(19) United States
(12) Patent Application Publication
(10) Pub. No.: US 2012/0196165 A1
(43) Pub. Date: Aug. 2, 2012

(54) ELECTRODE ASSEMBLY AND SECONDARY BATTERY INCLUDING ELECTRODE ASSEMBLY

(75) Inventor: Hoseong Kim, Yongin-si (KR)

(73) Assignee: Samsung SDI Co., Ltd., Yongin-si (KR)

(21) Appl. No.: 13/099,208

(22) Filed: May 2, 2011

(30) Foreign Application Priority Data
Jan. 31, 2011 (KR) 10-2011-0009406

(51) Int. Cl. H01M 4/00; H01M 2/14; H01M 2/02; H01M 4/64

(52) U.S. Cl. 429/94

(57) ABSTRACT

Provided is a secondary battery that can raise the strength of a case by including an electrode assembly that has a negative electrode plate in the outermost part. For example, illustrated is an electrode assembly including a negative electrode plate comprising a negative electrode collector, the negative electrode collector having a first negative electrode coating portion disposed on a side of the negative electrode collector and a second negative electrode coating portion disposed on the other side of the electrode collector, a positive electrode plate including a positive electrode collector, the positive electrode collector having a first positive electrode coating portion disposed on a side of the positive electrode collector and a second positive electrode coating portion disposed on the other side of the electrode collector, and a separator disposed between the negative electrode plate and the positive electrode plate, wherein the negative electrode plate is disposed in the outermost part when the negative electrode plate, the positive electrode plate, and the separator are wound.

### CROSS-REFERENCE TO RELATED APPLICATIONS

This application claims priority to Korean Patent Application No. 10-2011-0009406 filed on Jan. 31, 2011, in the Korean Intellectual Property Office, and entitled: “ELECTRODE ASSEMBLY AND SECONDARY BATTERY INCLUDING ELECTRODE ASSEMBLY” which is hereby incorporated by reference herein in its entirety.

### BACKGROUND

1. Field

Embodiments relate to an electrode assembly and a secondary battery including the same.

2. Description of the Related Art

Secondary batteries can be manufactured in various shapes such as a pouch shape, a cylindrical shape, and a prismatic shape. Pouch-type secondary batteries are relatively flexible in shaping and light in weight, and thus are widely used in portable electronic devices which have become slimmer and more lightweight recently.

A case of such a pouch-type secondary battery is attached with a thin metallic film, and insulation films on both sides thereof. This contrasts with cylindrical or prismatic-type batteries that are thick film metallic material. Such a case for a pouch-type battery is more freely bendable, and a space is formed in the case to contain an electrode assembly. Since such a case of a pouch type secondary battery is formed of a flexible material the strength of which is relatively low, it is often beneficial to increase the strength of the case.

### SUMMARY

Embodiments provide an electrode assembly which can help reduce manufacturing costs by not forming an unnecessary electrode coating portion, the electrode assembly having a negative electrode plate in the outermost part for raising a rigidity of a case, and a secondary battery including the same.

According to at least one of the embodiments, an electrode assembly includes: a negative electrode plate comprising a negative electrode collector, the negative electrode collector having a first negative electrode coating portion disposed on a side of the negative electrode collector and a second negative electrode coating portion disposed on the other side of the electrode collector; a positive electrode plate comprising a positive electrode collector, the positive electrode collector having a first positive electrode coating portion disposed on a side of the positive electrode collector and a second positive electrode coating portion disposed on the other side of the electrode collector; and a separator disposed between the negative electrode plate and the positive electrode plate, wherein the negative electrode plate is disposed in an outermost part when the negative electrode plate, the positive electrode plate, and the separator are wound.

The first negative electrode coating portion may be disposed from a first point to a second point, and the second negative electrode coating portion may be disposed from the first point to a third point, wherein the distance between the first point and the second point is shorter than the distance between the first point and the third point.

A first negative electrode non-coating portion may be disposed at an end of the negative electrode collector, and a second negative electrode non-coating portion may be disposed at the other end of the negative electrode collector, wherein a negative electrode tab is disposed on the first negative electrode non-coating portion.

The first negative electrode non-coating portion may be disposed at a center part of the electrode assembly.

The second negative electrode non-coating portion may be disposed in an outermost part of the electrode assembly.

The length of the second negative electrode non-coating portion may be longer than the length of the first negative electrode non-coating portion.

The first positive electrode coating portion may be disposed from a fourth point to a sixth point, and the second positive electrode coating portion may be disposed from a fifth point to the sixth point, wherein the distance between the fourth point and the sixth point is longer than the distance between the fifth point and the sixth point.

A positive electrode non-coating portion may be disposed at an end of the positive electrode collector, and a positive electrode non-coating portion may not be disposed at the other end of the positive electrode collector.

A positive electrode tab may be disposed on the positive electrode non-coating portion, and the positive electrode non-coating portion may be disposed at the center part of the electrode assembly.

Areas coated with the second negative electrode coating portion and the first positive electrode coating portion may be the same to each other.

The second negative electrode coating portion and the first positive electrode coating portion may be wound correspondingly to each other, wherein the separator is disposed between the second negative electrode coating portion and the first positive electrode coating portion.

Areas coated with the first negative electrode coating portion and the second positive electrode coating portion may be the same to each other.

The first negative electrode coating portion and the second positive electrode coating portion may be wound correspondingly to each other, wherein the separator is disposed between the first negative electrode coating portion and the second positive electrode coating portion.

According to another embodiment, a secondary battery includes: an electrode assembly comprising a negative electrode plate which comprises a negative electrode collector, the negative electrode collector having a first negative electrode coating portion disposed on a side of the negative electrode collector and a second negative electrode coating portion disposed on the other side of the electrode collector, a positive electrode plate which comprises positive electrode collector, the positive electrode collector having a first positive electrode coating portion disposed on a side of the positive electrode collector and a second positive electrode coating portion disposed on the other side of the electrode collector, and a separator disposed between the negative electrode plate and the positive electrode plate; and a case containing the electrode assembly, the case being formed of iron or stainless steel, wherein the negative electrode plate is disposed in the outermost part when the electrode assembly is wound.

The first negative electrode coating portion may be disposed from the first point to the second point, and the second negative electrode coating portion may be disposed from the first point to the third point, wherein the distance between the first point and the second point is shorter than the distance between the first point and the third point.

The first negative electrode non-coating portion may be disposed at the end of the negative electrode collector, and the second negative electrode non-coating portion may be disposed at the other end of the negative electrode collector, wherein the first negative electrode non-coating portion is disposed at the center part of the electrode assembly, and the second negative electrode non-coating portion is disposed in the outermost part of the electrode assembly.

The first positive electrode coating portion may be disposed from the fourth point to the sixth point, and the second positive electrode coating portion may be disposed from the fifth point to the sixth point, wherein the distance between the fourth point and the sixth point is longer than the distance between the fifth point and the sixth point.

The positive electrode non-coating portion may be disposed at the end of the positive electrode collector, and the positive electrode non-coating portion may not be disposed at the other end of the positive electrode collector, wherein the positive electrode non-coating portion is disposed at the center part of the electrode assembly.

Areas coated with the second negative electrode coating portion and the first positive electrode coating portion may be the same to each other, wherein the second negative electrode coating portion and the first positive electrode coating portion are wound correspondingly, and the separator is disposed between the second negative electrode coating portion and the first positive electrode coating portion.

Areas coated with the first negative electrode coating portion and the second positive electrode coating portion are the same to each other, wherein the first negative electrode coating portion and the second positive electrode coating portion are wound correspondingly, and the separator is disposed between the first negative electrode coating portion and the second positive electrode coating portion.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is an exploded perspective view illustrating an electrode assembly according to an embodiment;

FIG. 2 is a front view illustrating the electrode assembly according to an embodiment;

FIG. 3 is a sectional view showing a state in which the electrode assembly according to the embodiment is wound;

FIG. 4 is a sectional view showing a part in which the electrode assembly according to the embodiment starts to be wound; and

FIG. 5 is an exploded perspective view illustrating a secondary battery according to the embodiment.

### DETAILED DESCRIPTION

Korean Patent Application No. 10-2011-0009406 filed on Jan. 31, 2011, in the Korean Intellectual Property Office, and entitled: “ELECTRODE ASSEMBLY AND SECONDARY BATTERY INCLUDING ELECTRODE ASSEMBLY” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the disclosure to those skilled in the art.

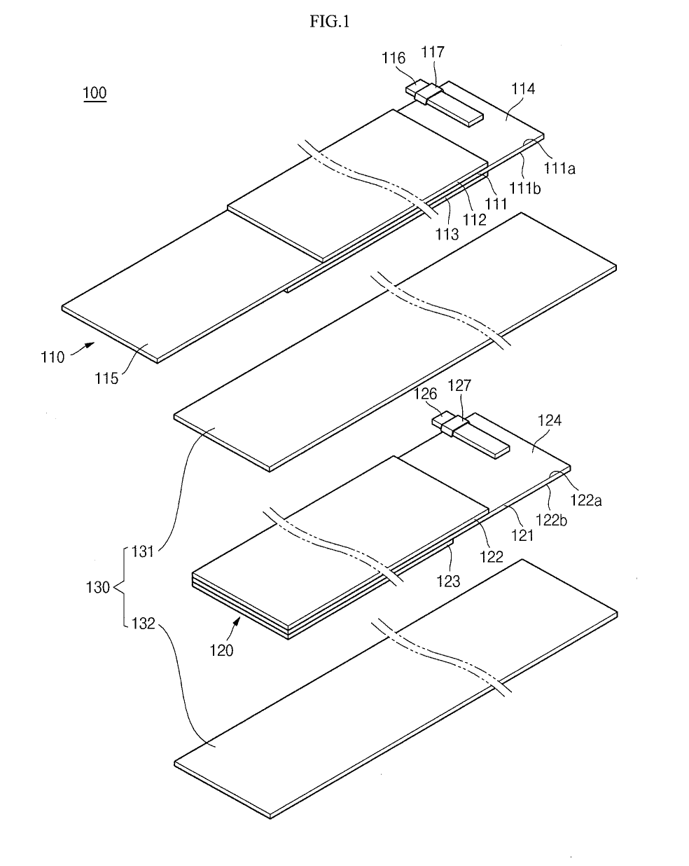

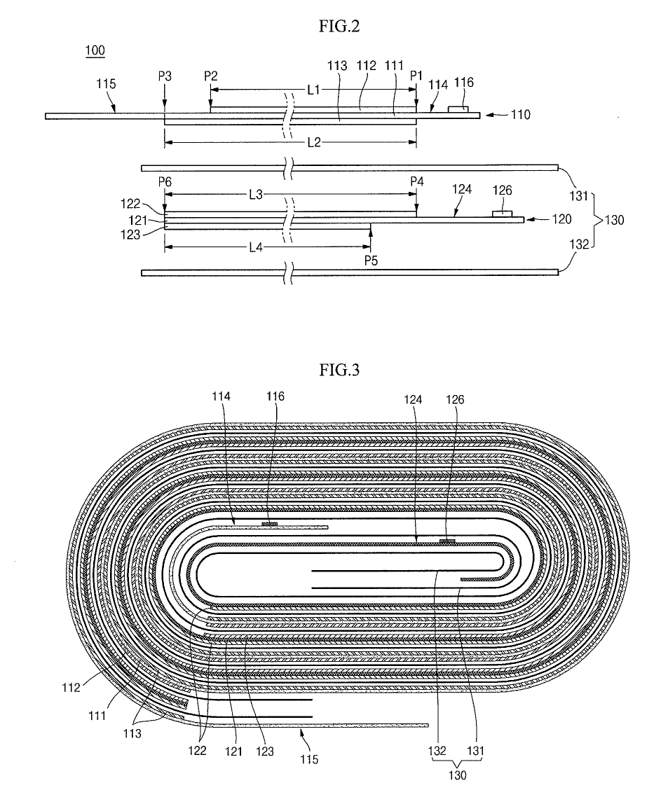

FIG. 1 is an exploded perspective view illustrating an electrode assembly according to an embodiment. FIG. 2 is a front view illustrating the electrode assembly in FIG. 1. FIG. 3 is a sectional view illustrating a state in which the electrode assembly according to the embodiment is wound. Hereinafter, the thickness of the electrode assembly illustrated in FIG. 1 or FIG. 3 may be expressed exaggeratedly and the length thereof may be expressed reduced for the convenience of explanation.

Referring to FIG. 1 or FIG. 3, the electrode assembly 100 of the embodiment includes a negative electrode plate 110, a positive electrode plate 120, and a separator 130.

The electrode assembly 100 is assembled in the form of a jelly roll by winding the negative electrode plate 110, the positive electrode plate 120, and the separator 130 disposed between the negative electrode plate 110 and the positive electrode plate 120. The negative electrode plate 110 is disposed in the outermost part of the electrode assembly 100.

The negative electrode plate 110 includes a negative electrode collector 111, a first negative electrode coating portion 112 disposed on a first side 111a of the negative electrode collector 111, and a second negative electrode coating portion 113 disposed on a second side 111b opposite to the first side 111a of the negative electrode collector 111. In addition, the negative electrode plate 110 includes a first negative electrode non-coating portion 114 which is a part of the negative electrode collector 111 not coated with the first negative electrode coating portion 112, and a second negative electrode non-coating portion 115 which is a part of the negative electrode collector 111 not coated with the second negative electrode coating portion 113.

The negative electrode collector 111 is a conductive metal plate having a thin plate shape or a thin film shape. The negative electrode collector 111 is formed of metal foil such as copper or nickel foil. The first negative electrode coating portion 112 is disposed on the first side 111a of the negative electrode collector 111, and the second negative electrode coating portion 113 is disposed on the second side 111b of the negative electrode collector 111. The negative electrode non-coating portions 114 and 115 are parts of the negative electrode collector 111 not coated with the first negative electrode coating portion 112 and the second negative electrode coating portion 113.

The first negative electrode coating portion 112 is disposed on the first side 111a of the negative electrode collector 111. The first negative electrode coating portion 112 may be formed by mixing a negative electrode active material with a conductive material such as carbon black or graphite powder and a binder for fixing an active material. A carbon-based material, Si, Sn, tin oxide, a composite tin alloy, a transition metal oxide, a lithium metal nitride, or a lithium metal oxide may be used as the negative electrode active material. However, in the current embodiment, the material of the negative electrode active material is not limited thereto.

The second negative electrode coating portion 113 is disposed on the second side 111b of the negative electrode collector 111. The second negative electrode coating portion 113 is formed of the same material as the material of the first negative electrode coating portion 112.

In addition, the first negative electrode coating portion 112 is disposed between a first point P1 and a second point P2 of the negative electrode collector 111, and the second negative electrode coating portion 113 is disposed between the first point P1 and a third point P3 of the negative electrode collector 111. Since the third point P3 is farther away from the first point P1 than the second point P2 is away from the first point P1, the distance L1 between the first point P1 and the second point P2 is shorter than the distance L2 between the first point P1 and the third point P3 (L1<L2). Therefore, the area of the negative electrode collector 111 coated with the first negative electrode coating portion 112 is narrower than the area of the negative electrode collector 111 coated with the second negative electrode coating portion 113.

The negative electrode non-coating portions 114 and 115 include the first negative electrode non-coating portion 114 disposed at an end of the negative electrode collector 111, and the second negative electrode non-coating portion 115 disposed at the other end of the negative electrode collector 111.

The first negative electrode non-coating portion 114 is disposed at the end of the negative electrode collector 111, and is a part in which a negative electrode active material is not disposed. In other words, the first negative electrode non-coating portion 114 is the part from the end of the negative electrode collector 111 to the first point P1 at which the first negative electrode coating portion 112 or the second negative electrode coating portion 113 is disposed. Therefore, the first negative electrode non-coating portion 114 is equally disposed on the first side 111a and the second side 111b of the negative electrode collector 111. The first negative electrode non-coating portion 114 is disposed at a center part of the electrode assembly 100 when the electrode assembly 100 is wound.

In addition, a negative electrode tab 116 is disposed on the first negative electrode non-coating portion 114, and is formed of a metal such as copper or nickel. An end of the negative electrode tab 116 is electrically connected to the first negative electrode non-coating portion 114, and the other end extends outward. The negative electrode tab 116 transfers electrons collected on the negative electrode collector 111 to an external circuit. In addition, the negative electrode tab 116 may be attached to the first negative electrode non-coating portion 114 by an insulation unit 117. The insulation unit 117 inhibits a short circuit between the negative electrode tab 116 and a positive electrode tab 126 and between the negative electrode tab 116 and a positive electrode collector 121. The insulation unit 117 may be formed of a material which can inhibit such a short circuit and is resistant to electrolyte. For example, the insulation unit 117 may be formed of an insulation tape containing polyphenylene sulfide (PS), polyimide (PI), or polypropylene (PP).

The second negative electrode non-coating portion 115 is disposed at the other end of the negative electrode collector 111, and is a part in which a negative electrode active material is not disposed. In other words, the second negative electrode non-coating portion 115 is the part from the other end of the negative electrode collector 111 to the second point P2 at which the first negative electrode coating portion 112 is disposed and to the third point P3 at which the negative electrode coating portion 113 is disposed. Therefore, the second negative electrode non-coating portion 115 is not equally disposed on the first side 111a and the second side 111b of the negative electrode collector 111. In addition, the second negative electrode non-coating portion 115 is disposed in the outermost part when the electrode assembly 100 is wound. Here, the second negative electrode non-coating portion 115 disposed on the first side 111a of the negative electrode collector 111 is disposed in the outermost part, and the length of the second negative electrode non-coating portion 115 is sufficient to surround the outermost part of the electrode assembly 100. Therefore, the length of the second negative electrode non-coating portion 115 is relatively larger than the length of the first negative electrode non-coating portion 114.

The positive electrode plate 120 includes the positive electrode collector 121, a first positive electrode coating portion 122 disposed on a first side 121a of the positive electrode collector 121, and a second positive electrode coating portion 123 disposed on a second side 121b opposite to the first side 121a of the positive electrode collector 121. In addition, the positive electrode plate 120 includes a positive electrode non-coating portion 124 which is a part of the positive electrode collector 121 not coated with the first positive electrode coating portion 122 and the second positive electrode coating portion 123. The positive electrode non-coating portion 124, contrary to the negative electrode non-coating portions 114 and 115 which are disposed at both ends of the negative electrode plate 110, is disposed at only an end of the positive electrode plate 120.

The positive electrode collector 121 is a conductive metal plate having a thin plate shape or a thin film shape. The positive electrode collector 121 is formed of metal foil such as aluminum foil. The first positive electrode coating portion 122 is disposed on the first side 121a of the positive electrode collector 121, and the second positive electrode coating portion 123 is disposed on the second side 122b of the positive electrode collector 121. The positive electrode non-coating portion 124 is a part of the positive electrode collector 121 not coated with the first positive electrode coating portion 122 and the second positive electrode coating portion 123.

The first positive electrode coating portion 122 is disposed on the first side 121a of the positive electrode collector 121. The first positive electrode coating portion 122 may be formed by mixing a positive electrode active material with a conductive material such as carbon black or graphite powder and a binder for fixing an active material. A chalcogenide compound which is a composite metal oxide such as LiCoO₂, LiMn₂O₄, LiNiO₂ and LiNiMnO₂ may be used as the positive electrode active material. However, in the current embodiment, the material of the positive electrode active material is not limited thereto.

The second positive electrode coating portion 123 is disposed on the second side 121b of the positive electrode collector 121. The second positive electrode coating portion 123 is formed of the same material as the material of the first positive electrode coating portion 122.

The first positive electrode coating portion 122 is disposed between a fourth point P4 and a sixth point P6 of the positive electrode collector 121, and the second positive electrode coating portion 123 is disposed between a fifth point P5 and the sixth point P6 of the positive electrode collector 121.

Since the fourth point P4 is farther away from the sixth point P6 than the fifth point P5 is away from the sixth point P6, the distance L3 between the fourth point P4 and the sixth point P6 is longer than the distance L4 between the fifth point P5 and the sixth point P6 (L3>L4). Therefore, the area of the positive electrode collector 121 coated with the first positive electrode coating portion 122 is wider than the area of the positive electrode collector 121 coated with the second positive electrode coating portion 123.

In addition, the area coated with the first positive electrode coating portion 122 is the same as the area coated with the second negative electrode coating portion 113. In other words, the horizontal length L3 of the area coated with the first positive electrode coating portion 122 is the same as the horizontal length L2 of the area coated with the second negative electrode coating portion 113 (L2=L3). When the electrode assembly 100 is wound, the first positive electrode coating portion 122 and the second negative electrode coating portion 113 are wound correspondingly, and the separator 130 is disposed between the first positive electrode coating portion 122 and the second negative electrode coating portion 113.

Further, the area coated with the second positive electrode coating portion 123 is the same as the area coated with the first negative electrode coating portion 112. In other words, the horizontal length L4 of the area coated with the second positive electrode coating portion 123 is the same as the horizontal length L1 of the area coated with the first negative electrode coating portion 112 (L1=L4). When the electrode assembly 100 is wound, the second positive electrode coating portion 123 and the first negative electrode coating portion 112 are wound correspondingly, and the separator 130 is disposed between the second positive electrode coating portion 123 and the first negative electrode coating portion 112.

As described above, the positive electrode coating portions 122 and 123 are formed and have substantially the same areas as the areas of the negative electrode coating portions 112 and 113, and the negative electrode coating portions 112 and 113 are formed and have substantially the same areas as the areas of the positive electrode coating portions 122 and 123. Therefore, since the positive electrode plate 120 and the negative electrode plate 110 do not form unnecessary electrode coating portions, the thickness of the electrode assembly 100 may be reduced, and manufacturing costs may be reduced.

The positive electrode non-coating portion 124 is disposed at an end of the positive electrode collector 121, and is a part in which a positive electrode active material is not disposed. In other words, the positive electrode non-coating portion 124 is the part from the end of the positive electrode collector 121 to the fourth point P4 at which the first positive electrode coating portion 122 is disposed or to the fifth point P5 at which the second positive electrode coating portion 123 is disposed. Therefore, the positive electrode non-coating portion 124 is not equally disposed on the first side 121a and the second side 121b of the positive electrode collector 121.

In addition, the positive electrode tab 126 is disposed on the positive electrode non-coating portion 124, and is formed of a metal such as aluminum. An end of the positive electrode tab 126 is electrically connected to the positive electrode non-coating portion 124, and the other end extends outward. The positive electrode tab 126 transfers electrons collected on the positive electrode collector 121 to an external circuit. In addition, the positive electrode tab 126 may be attached to the positive electrode non-coating portion 124 by an insulation unit 127. The insulation unit 127 is the same as the insulation unit 117 disposed on the negative electrode tab 116, and thus a detailed illustration will not be repeated.

The separator 130 is disposed between the negative electrode plate 110 and the positive electrode plate 120, and inhibits short circuits between the negative electrode plate 110 and the positive electrode plate 120. The separator 130 includes a first separator 131 and a second separator 132. The first separator 131 is disposed between the second negative electrode coating portion 113 and the first positive electrode coating portion 122, and has an area larger than the areas coated with the second negative electrode coating portion 113 and the first positive electrode coating portion 122. In addition, the second separator 132 is disposed between the first negative electrode coating portion 112 and the second positive electrode coating portion 123, and has an area larger than the areas coated with the first negative electrode coating portion 112 and the second positive electrode coating portion 123.

The separator 130 may be formed of a material selected from the group consisting of polyethylene, polypropylene, and a copolymer of polyethylene and polypropylene. However, in the current embodiment, the material of the separator 130 is not limited thereto.

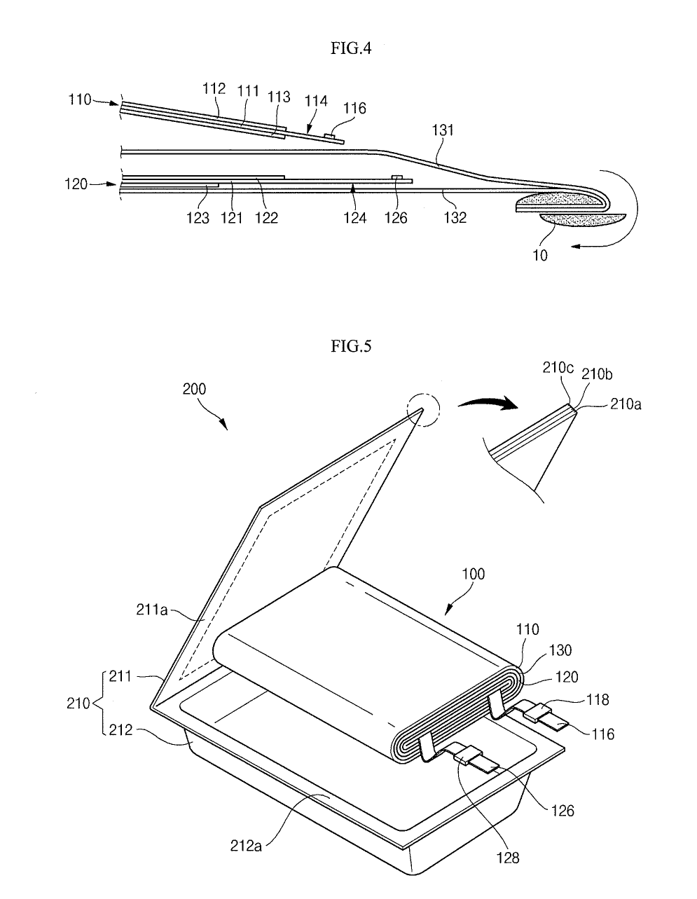

FIG. 4 is a sectional view showing a part of the electrode assembly at which the electrode assembly starts to be wound according to the embodiment.

Referring to FIG. 4, first of all, a part of the first separator 131 and a part of the second separator 132 are wound around a mandrel 10. Then, the positive electrode plate 120 is disposed between the first separator 131 and the second separator 132, the negative electrode plate 110 is disposed on the outer side of the first separator 131, and the positive electrode plate 120 and the negative electrode plate 110 are wound together with the first separator 131 and the second separator 132. In this case, the negative electrode plate 110 is stacked and wound at a location where the first positive electrode coating portion 122 of the positive electrode plate 120 corresponds to the second negative electrode coating portion 113 of the negative electrode plate 110. The electrode assembly 100 is formed by sequentially stacking and winding the second separator 132, the positive electrode plate 120, the first separator 131, and the negative electrode plate 110. Here, the positive electrode non-coating portion 124 is a portion that is first wound in the positive electrode plate 120, and the first negative electrode non-coating portion 114 is a portion that is first wound in the negative electrode plate 110. Therefore, the negative electrode tab 116 and the positive electrode tab 126 are disposed at the center part of the electrode assembly 100, and the second negative electrode non-coating portion 115 of the negative electrode plate 110 is disposed in the outermost part of the electrode assembly 100.

As described above, in the electrode assembly 100 according to the embodiment, the first negative electrode coating portion 112 and the second positive electrode coating portion 123 correspond to each other and have the same area, and the second negative electrode coating portion 113 and the first positive electrode coating portion 122 correspond to each other and have the same area. Therefore, because the electrode assembly 100 of the embodiment does not have an unnecessary electrode coating portion on the negative electrode plate 110 and the positive electrode plate 120, the electrode assembly 100 of the embodiment can be reduce in thickness and can be manufactured with lower costs.

The followings are an illustration of a secondary battery including the electrode assembly.

FIG. 5 is an exploded perspective view illustrating a secondary battery according to an embodiment.

Referring to FIG. 5, a secondary battery 200 of the embodiment includes the electrode assembly 100, and a case 210 in which the electrode assembly 100 is contained.

The electrode assembly 100 is formed by winding the negative electrode plate 110 to which the negative electrode tab 116 is connected, the positive electrode plate 120 to which the positive electrode tab 126 is connected, and the separator 130 which is disposed between the negative electrode plate 110 and the positive electrode plate 120. In this case, the negative electrode plate 110 is disposed in the outermost part of the electrode assembly 100. The electrode assembly 100 is the same as the electrode assembly 100 illustrated above, and thus a detailed illustration will not be repeated. However, on the negative electrode tab 116 and the positive electrode tab 126, adhesive tapes 118 and 128 that help seal the case 210 may be disposed in the portions where sealing portions 211a and 212a of the case 210 are overlapped.

The case 210 is a pouch type case including an upper case 211 and a lower case 212. The upper case 211 and the lower case 212 are connected to each other on one side and are not connected to each other on the other sides, and thus the electrode assembly 100 can be contained in the case 210. Here, the lower case 212 has a space in which the electrode assembly 100 can be contained. Along the edges of the upper case 211 and the lower case 212, the upper sealing portion 211a and the lower sealing portion 212a which are sealed by a method such as thermal bonding are disposed.

The case 210 has a multi-layered structure including a thermal bonding layer 210a, a metal layer 210b, and an insulation film 210c. The thermal bonding layer 210a has a thermal bonding property to seal the upper case 211 and the lower case 212. The metal layer 210b maintains a mechanical strength of the case 210, and inhibits moisture and oxygen from permeating from outside. The metal layer 210b may be formed of iron (Fe) or stainless steel (SUS) to raise the mechanical strength of the case 210.

In addition, in the embodiment, the negative electrode plate 110 formed of copper is disposed in the outermost part of the electrode assembly 100. Therefore, an electric potential difference between the case 210 formed of Fe or SUS and the electrode assembly 100 is less than an electric potential difference between a case formed of aluminum and the electrode assembly 100. Thus, the possibility of a short circuit or corrosion between the electrode assembly 100 and the case 210 is reduced.

As described above, the secondary battery 200 of the embodiment can raise the strength of the case 210 by including the electrode assembly 100 having the negative electrode plate 110 in the outermost part.

According to the electrode assembly of the embodiment, the thickness of the electrode assembly may be reduced, and manufacturing costs may be reduced.

In addition, the secondary battery of the embodiment includes the electrode assembly having a negative electrode plate on the outermost part, and thus the strength of the case can be raised.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. An electrode assembly comprising:
a negative electrode plate comprising a negative electrode collector, the negative electrode collector having a first negative electrode coating portion disposed on a first side of the negative electrode collector and a second negative electrode coating portion disposed on the second side of the electrode collector;
a positive electrode plate comprising a positive electrode collector, the positive electrode collector having a first positive electrode coating portion disposed on a first side of the positive electrode collector and a second positive electrode coating portion disposed on the second side of the electrode collector; and
a separator disposed between the negative electrode plate and the positive electrode plate,
wherein the negative electrode plate, the positive electrode plate and the separator are wound so that the negative electrode plate is disposed in the outermost part.

2. The electrode assembly as claimed in claim 1, wherein the first negative electrode coating portion is disposed from a first point to a second point, and the second negative electrode coating portion is disposed from the first point to a third point,
wherein a distance between the first point and the second point is shorter than a distance between the first point and the third point.

3. The electrode assembly as claimed in claim 1, wherein a first negative electrode non-coating portion is disposed at an end of the negative electrode collector, and a second negative electrode non-coating portion is disposed at the other end of the negative electrode collector,
wherein a negative electrode tab is disposed on the first negative electrode non-coating portion.

4. The electrode assembly as claimed in claim 3, wherein the first negative electrode non-coating portion is disposed at a center part of the electrode assembly.

5. The electrode assembly as claimed in claim 3, wherein the second negative electrode non-coating portion is disposed in the outermost part of the electrode assembly.

6. The electrode assembly as claimed in claim 3, wherein a length of the second negative electrode non-coating portion is longer than a length of the first negative electrode non-coating portion.

7. The electrode assembly as claimed in claim 1, wherein the first positive electrode coating portion is disposed from a fourth point to a sixth point, and the second positive electrode coating portion is disposed from a fifth point to the sixth point,
wherein a distance between the fourth point and the sixth point is longer than a distance between the fifth point and the sixth point.

8. The electrode assembly as claimed in claim 1, wherein a positive electrode non-coating portion is disposed at an end of the positive electrode collector, and a positive electrode non-coating portion is not disposed at the other end of the positive electrode collector.

9. The electrode assembly as claimed in claim 8, wherein a positive electrode tab is disposed on the positive electrode non-coating portion, and the positive electrode non-coating portion is disposed at a center part of the electrode assembly.

10. The electrode assembly as claimed in claim 1, wherein areas coated with the second negative electrode coating portion and the first positive electrode coating portion are equal.

11. The electrode assembly as claimed in claim 1, wherein the second negative electrode coating portion and the first positive electrode coating portion are wound correspondingly to each other,
wherein the separator is disposed between the second negative electrode coating portion and the first positive electrode coating portion.

12. The electrode assembly as claimed in claim 1, wherein areas coated with the first negative electrode coating portion and the second positive electrode coating portion are equal.

13. The electrode assembly as claimed in claim 1, wherein the first negative electrode coating portion and the second positive electrode coating portion are wound correspondingly to each other,
wherein the separator is disposed between the first negative electrode coating portion and the second positive electrode coating portion.

14. A secondary battery comprising:
an electrode assembly; and
a case containing the electrode assembly, the case being formed of iron or stainless steel,
wherein the electrode assembly comprises:
a negative electrode plate which comprises a negative electrode collector, the negative electrode collector having a first negative electrode coating portion disposed on a first side of the negative electrode collector and a second negative electrode coating portion disposed on a second side of the electrode collector;
a positive electrode plate which comprises a positive electrode collector, the positive electrode collector having a first positive electrode coating portion disposed on a first side of the positive electrode collector and a second positive electrode coating portion disposed on a second side of the electrode collector; and
a separator disposed between the negative electrode plate and the positive electrode plate,
wherein the positive electrode plate, the negative electrode plate and the separator are wound so that the negative electrode plate is disposed on the outermost part.

15. The secondary battery as claimed in claim 14, wherein the first negative electrode coating portion is disposed from a first point to a second point, and the second negative electrode coating portion is disposed from the first point to a third point,
wherein a distance between the first point and the second point is shorter than a distance between the first point and the third point.

16. The secondary battery as claimed in claim 14, wherein a first negative electrode non-coating portion is disposed at an end of the negative electrode collector, and a second negative electrode non-coating portion is disposed at the other end of the negative electrode collector,
wherein the first negative electrode non-coating portion is disposed at a center part of the electrode assembly, and the second negative electrode non-coating portion is disposed in the outermost part of the electrode assembly.

17. The secondary battery as claimed in claim 14, wherein the first positive electrode coating portion is disposed from a fourth point to a sixth point, and the second positive electrode coating portion is disposed from a fifth point to the sixth point,
wherein a distance between the fourth point and the sixth point is longer than a distance between the fifth point and the sixth point.

18. The secondary battery as claimed in claim 14, wherein a positive electrode non-coating portion is disposed at an end of the positive electrode collector, and a positive electrode non-coating portion is not disposed at the other end of the positive electrode collector,
wherein the positive electrode non-coating portion is disposed at a center part of the electrode assembly.

19. The secondary battery as claimed in claim 14, wherein areas coated with the second negative electrode coating portion and the first positive electrode coating portion are equal,
wherein the second negative electrode coating portion and the first positive electrode coating portion are wound correspondingly, and the separator is disposed between the second negative electrode coating portion and the first positive electrode coating portion.

20. The secondary battery as claimed in claim 14, wherein areas coated with the first negative electrode coating portion and the second positive electrode coating portion are equal,
wherein the first negative electrode coating portion and the second positive electrode coating portion are wound correspondingly, and the separator is disposed between the first negative electrode coating portion and the second positive electrode coating portion.
